(19) United States
(12) Patent Application Publication
(10) Pub. No.: US 2025/0022031 A1
(43) Pub. Date: Jan. 16, 2025

(54) METHOD FOR PROVIDING SERVICE-RELATED DATA

(71) Applicants: Tsung-Hsiu YU, Tainan City (TW); Chun-Ching WANG, Tainan City (TW); Shih-Wei CHEN, Kaohsiung City (TW)

(72) Inventors: Tsung-Hsiu YU, Tainan City (TW); Chun-Ching WANG, Tainan City (TW); Shih-Wei CHEN, Kaohsiung City (TW)

(21) Appl. No.: 18/665,083

(22) Filed: May 15, 2024

Related U.S. Application Data
(60) Provisional application No. 63/625,596, filed on Jan. 26, 2024.
(60) Provisional application No. 63/466,797, filed on May 16, 2023.

(51) Int. Cl. G06Q 30/0601

(52) U.S. Cl. CPC G06Q 30/0627; G06Q 30/0639; G06Q 30/0641

(57) ABSTRACT

A method for providing service-related data includes: obtaining header information associated with a merchant based on registration information associated with the merchant, the registration information at least including a location of the merchant; based on product data associated with the merchandise, obtaining merchandise-related data associated with a merchandise provided by the merchant; obtaining content information based on the product data and the merchandise-related data; generating the service-related data using the header information and the content information; and transmitting the service-related data to a server as an entry of to-be-searched service-related data to enable the server to store the entry of to-be-searched service-related data in a data storage.

### CROSS-REFERENCE TO RELATED APPLICATION

This application claims the benefits of U.S. Provisional Patent Application No. 63/466,797, filed on May 16, 2023, and U.S. Provisional Patent Application No. 63/625,596, filed on Jan. 26, 2024, the entire disclosures of which are incorporated by reference herein.

### FIELD

The disclosure relates to a method for providing data, and more particularly to a method for providing service-related data via an artificial intelligence (AI) assistant.

### BACKGROUND

As AI-related technology progresses, AI assistants have emerged as computer program tools that employ large language models (LLM) to help complete tasks for users. For example, existing AI assistant devices such as Ai Pin, Rabbit R1, etc., are capable of helping a user complete a number of everyday tasks such as calling a cab, ordering a food delivery, making a phone call, performing an online search based on a specified search term, etc.

Typically, when a user instructs an AI assistant to perform an online search for a specific merchandise or place an order for the specific merchandise, the AI assistant may return with a website of a merchant of the specific merchandise, or an online shopping platform that lists the specific merchandise, and merchants that do not have a website or do not have their merchandise listed on any online shopping platform would not be reachable by the AI assistant.

For some independent merchants, launching products online may not be their first priorities due to the associated cost (such as building and maintaining a website, fees paid to the online shopping platform, etc.).

### SUMMARY

It may be desirable for some independent merchants not having their own websites or not working with known service platforms to be able to reach additional potential customers. Additionally, for users seeking a specific merchandise or a specific service, it may be beneficial to reach more merchants who are otherwise difficult to reach.

Therefore, an object of the disclosure is to provide a method that can alleviate at least one of the drawbacks of the prior art.

According to one embodiment of the disclosure, the method for providing service-related data is implemented using a service system that is connected to a server via a network. The server includes a data storage. The service system including a merchant-end device that executes a first artificial intelligence (AI) assistant software program. The method includes:
a) obtaining, by the merchant-end device executing the first AI assistant software program, header information associated with a merchant based on registration information associated with the merchant, the registration information at least including a location of the merchant;
b) obtaining, by the merchant-end device executing the first AI assistant software program and based on product data that is associated with the merchandise and that is provided by the merchant, merchandise-related data associated with a merchandise provided by the merchant;
c) obtaining, by the merchant-end device executing the first AI assistant software program, content information based on the product data and the merchandise-related data;
d) generating, by the merchant-end device executing the first AI assistant software program, the service-related data using the header information and the content information;
performing a signature operation by executing an asymmetric cryptography algorithm to generate a digital signature using a secret key, and attaching the digital signature to the service-related data; and
e) transmitting, by the merchant-end device executing the first AI assistant software program, the service-related data to the server as an entry of to-be-searched service-related data to enable the server to store the entry of to-be-searched service-related data in the data storage.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a service system according to one embodiment of the disclosure.

FIG. 2 is a flow chart illustrating steps of an exemplary process for generating and uploading service-related data included in a method for providing the service-related data according to one embodiment of the disclosure.

FIG. 3 is a flow chart illustrating steps of an exemplary process for obtaining the service-related data included in the method for providing service-related data according to one embodiment of the disclosure.

FIG. 4 is a flow chart illustrating sub-steps regarding how a client-end device obtains a qualified entry of service-related data.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

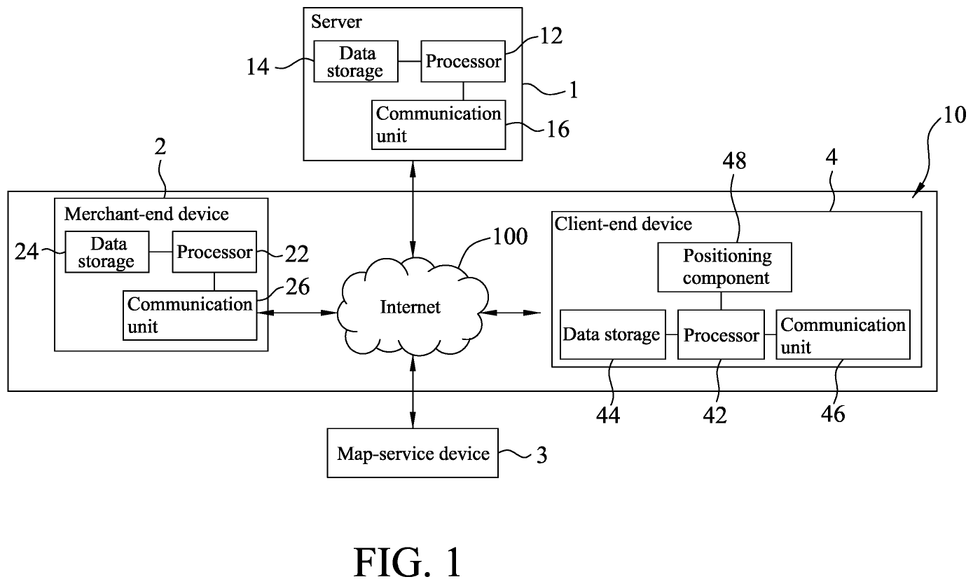

FIG. 1 is a block diagram illustrating a service system 10 according to one embodiment of the disclosure. In this embodiment, the service system 10 includes a merchant-end device 2 and a client-end device 4. In embodiments, the service system 10 may be connected to a server 1 and a map-service device 3 via a network (e.g., the Internet 100).

The server 1 may be embodied using a cloud server or a network storage server, and includes a processor 12, a data storage 14 and a communication unit 16.

The processor 12 may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage 14 is connected to the processor 12, and may be embodied using, for example, random access memory (RAM), read only memory (ROM), programmable ROM (PROM), firmware, flash memory, etc. In this embodiment, the data storage 14 stores a software application therein and includes a plurality of memory blocks for storing various data.

The communication unit 16 is connected to the processor 12, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or fifth generation (5G) of wireless mobile telecommunications technology, or the like.

The merchant-end device 2 may be embodied using a personal computer, a laptop, a tablet, a smartphone, or other suitable electronic devices that are capable of performing the operations as described below. In some embodiments, the merchant-end device 2 may be embodied using a commercially available artificial intelligence (AI) assistant device (e.g., Humane Ai Pin®, Rabbit R1®, etc.). In embodiments, the merchant-end device 2 is associated with a merchant that provides a merchandise (which may be a commodity for sale or a service). The merchant-end device 2 includes a processor 22, a data storage 24, and a communication unit 26.

The processor 22 may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage 24 is connected to the processor 22, and may be embodied using, for example, random access memory (RAM), read only memory (ROM), programmable ROM (PROM), firmware, flash memory, etc. In some embodiments, the data storage 24 stores a software application therein for enabling the merchant-end device 2 to implement the operations as described below. In embodiments, the software application may be an AI assistant application.

The communication unit 26 is connected to the processor 22, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or fifth generation (5G) of wireless mobile telecommunications technology, or the like.

The map-service device 3 may be a map server that is associated with a digital map service provider, such as Google®, Apple®, etc. In use, other electronic devices may access the map-service device 3 to obtain information regarding a digital map.

In some embodiments, the client-end device 4 may be embodied using a commercially available AI assistant device (e.g., Humane Ai Pin®, Rabbit R1®, etc.), and is held by a client. The client-end device 4 includes a processor 42, a data storage 44, a communication unit 46, and a positioning component 48. The processor 24, the data storage 44 and the communication unit 46 may be embodied using components that are similar to the processor 22, the data storage 24, and the communication unit 26, respectively. The positioning component 48 is connected to the processor 42, and may be embodied using a global positioning system (GPS) component or other suitable components that are capable of determining a location of the client-end device 4.

Alternatively, the client-end device 4 may be embodied using a client server that is connected with an electronic device held by the client. In some embodiments, the client-end device 4 may be an electronic device that executes an AI assistant software program and that is connected to the map-service device 3. In some embodiments, the map-service device 3 and the client-end device 4 may be integrated using a same server.

In use, the merchant may be interested in operating the merchant-end device 2 to upload information associated with the merchant, so as to enable other parties to locate the merchant via search. For example, the merchant may be interested to reach a user operating the client-end device 4 to search for the merchandise provided by the merchant. As such, embodiments of the disclosure provide a method for providing service-related data.

In embodiments, the method may include a process for generating and uploading the service-related data by the merchant-end device 2 and a process for obtaining the service-related data by the client-end device 4.

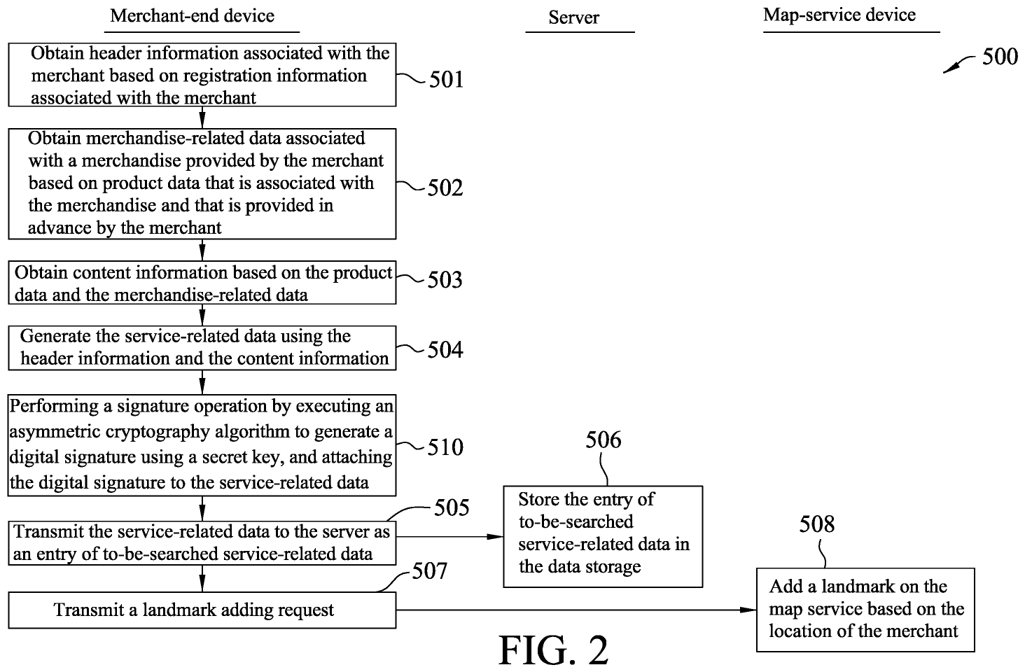

FIG. 2 is a flow chart illustrating steps of an exemplary process for generating and uploading the service-related data included in the method for providing service-related data via an AI assistant software program, according to one embodiment of the disclosure. In the embodiment of FIG. 2, the process is implemented by a merchant-end staff operating the merchant-end device 2, which is an AI assistant device that interacts with the server 1 and the map-service device 3. In some embodiments, the merchant-end device 2 may be an electronic device that executes the AI assistant software program. Generally, the AI assistant software program of the merchant-end device 2 utilizes a large language model (LLM) that is trained to perform tasks as described below. In some embodiments, the AI assistant software program is built with an application programming interface (API) calling to the LLM for inputting a prompt and obtaining a response.

In some embodiments, the merchant-end staff may apply in person to an AI service provider for a merchant account through a registration process. In the registration process, the merchant-end staff may be required to provide a Registration of Profit-seeking Enterprise or other proof of identity. Then, the merchant-end staff may operate the merchant-end device 2 to log into a service system provided by the AI service provider to proceed with the process for generating and uploading the service-related data. Additionally, the AI service provider may provide the merchant-end staff with a public key and a corresponding private key (i.e., a key pair) associated with the merchant account for subsequent use.

In step 501, based on registration information associated with the merchant, the merchant-end device 2 obtains header information associated with the merchant. In embodiments, the registration information may be manually inputted by the merchant-end staff via an input form provided by the merchant-end device 2, or may be obtained by the merchant-end device 2 in other manners (e.g., the merchant-end device 2 retrieving from the service system the registration information that was provided to the AI service provider while applying for the merchant account). The registration information at least includes a location of the merchant, a name of the merchant, and a category associated with the merchant (e.g., one or more of apparel, food, beverage, hairstyling, shipping service, publishing, dressmaking, etc.), the merchant account and the public key associated with the merchant account. The location of the merchant may be the location of a store, a stand or a workshop associated with the merchant (e.g., in the form of a set of GPS coordinates that may be obtained using an electronic device with a GPS component, or a physical address that may be inputted by the merchant-end staff).

The header information may be in the form of a specific format. For example, for the convenience of transmitting, storing or processing the data, the header information may be in the form of a serialization format such as JavaScript Object Notation (JSON), Extensible Markup Language (XML), etc. In the embodiment of FIG. 2, the merchant-end device 2 is configured to transform the registration information into the specific format (e.g., performing a serialization) using the AI assistant software program, so as to obtain the header information. As such, the header information thus obtained includes the content of the registration information (e.g., the location of the merchant, the name of the merchant, etc.).

In step 502, based on product data that is associated with the merchandise and that is provided in advance by the merchant, the merchant-end device 2 obtains merchandise-related data associated with a merchandise provided by the merchant.

Specifically, the merchant-end device 2 may be configured to perform, by the AI assistant software program, a search for domain knowledge (knowledge of a specific discipline or field) associated with the merchandise based on the product data so as to obtain the merchandise-related data. In embodiments, the domain knowledge may be provided by a third party, may be stored in an online database, and may be in the form of a plurality of domain knowledge datasets that are categorized based on the different fields. For example, the domain knowledge datasets associated with a food product or a health supplementary product may include one or more of a nutrition fact table, a test report that is associated with the product and that may be conducted by SGS S.A., a scientific name, an informal name, a usage restriction (e.g., potential allergies associated with a certain ingredient, specific food additives that may cause certain conditions, etc.), a two-dimensional (2D) image of the product, a three-dimensional (3D) image of the product, etc. In different fields, the domain knowledge datasets may include different contents. For example, in the cases that a specific type of service is involved (e.g., automotive sheet metal painting), the associated domain knowledge datasets may include keywords such as “car scratch and swirl removal” for assisting in search engine optimization (SEO). In other embodiments, in the cases that a specific type of service is solicited from a service supplier, the associated domain knowledge datasets may include requirements such as certifications and qualifications for specific jobs.

The AI assistant software program of the merchant-end device 2 uses the product data as a query and the domain knowledge datasets as a retrieved document in performing retrieval-augmented generation (RAG) related to the LLM so as to obtain an answer from the LLM which serves as the merchandise-related data. As such, the merchandise-related data thus obtained may include one or more of a characteristic of the merchandise, a usage restriction of the merchandise, a photo of the merchandise, a 3D representation (e.g., 3D object) of the merchandise, a shading language script (such as an Open Graphics Library, OpenGL, shader script) associated with the 3D representation, a link that is associated with an web address that stores the photo of the merchandise, the 3D representation of the merchandise and the shading language script associated with the 3D representation for an augmented reality (AR) system, a sales message (e.g., “In celebrating Christmas, special offer for the fruit cakes—70% off”) etc. Each item included in the merchandise-related data may be represented using a Uniform Resource Identifier (URI). It is noted that the operations of performing a search for the domain knowledge may be readily available in the related fields, so details thereof are omitted herein for the sake of brevity.

Then, in step 503, the merchant-end device 2 obtains content information based on the product data and the merchandise-related data. Specifically, the content information may be in the form of a specific format. For example, the content information may be in the form of the serialization format such as JSON, XML, etc. In the embodiment of FIG. 2, the merchant-end device 2 is configured to transform the product data and the merchandise-related data into the specific format (e.g., performing a serialization) using the AI assistant software program, so as to obtain the content information. In one embodiment, the merchant-end device 2 may first combine the product data and the merchandise-related data and then transform the combined product data and merchandise-related data into the specific format. As such, the content information thus obtained retains the content of the product data and the merchandise-related data.

Then, in step 504, the merchant-end device 2 generates the service-related data using the header information and the content information. Specifically, the merchant-end device 2 may merge the header information obtained in step 501 and the content information obtained in step 503 to generate the service-related data.

In some embodiments, after merging the header information and the content information to generate the service-related data in step 504, the merchant-end device 2 may further perform a signature operation to generate a digital signature, and attach the digital signature to the service-related data. For example, in step 510, the merchant-end device 2 may execute a digital signature algorithm (DSA) or other suitable algorithm (e.g., an asymmetric cryptography algorithm) to generate a digital signature using a secret key that is associated with the public key provided to the merchant. Then, the digital signature may be attached to the service-related data. In some cases, the digital signature may further include verification information, a time stamp indicating the time in which the digital signature is generated, and a valid duration of the digital signature (e.g., six months or longer, such as from 00:01 of Jan. 1, 2023 to 23:59 of Dec. 31, 2027). In the case that the service-related data includes a sales message, an additional valid duration associated with the sales message (e.g., from 08:00 of Dec. 15, 2024 to 22:00 of Dec. 25, 2024) may also be attached. In such cases, after the valid duration for the sales message is expired, the sales message may be archived and therefore is unable to be searched, but still may be provided to an authority (e.g., for reference in a lawsuit).

In step 505, the merchant-end device 2 transmits the service-related data to the server 1 as an entry of to-be-searched service-related data.

In embodiments, the service-related data transmitted to the server 1 may be in the form of a message post with a plurality of attachments including, for example, the digital signature, a genre of the message post such as civic service, advertisement, alarm, need help, system information, etc. The attachments may also be in the form of URIs. Since the message post is encoded in a manner that can be searched using the AI assistant, and as the information included in the message post is more complete, the message post may be easier to be obtained in a search operation by the AI assistant.

In step 506, in response to receipt of the entry of to-be-searched service-related data, the server 1 stores the entry of to-be-searched service-related data in the data storage 14. Then, the server 1 generates an access link to the entry of to-be-searched service-related data stored in the data storage 14, and transmits the access link to the merchant-end device 2.

It should be noted that the AI assistant mentioned in this disclosure may refer to the AI assistant device or the AI assistant software program, depending on the context of the sentence.

Then, in step 507, the merchant-end device 2 transmits a landmark adding request that includes the access link and the location of the merchant included in the registration information to the map-service device 3 as a request for display of the merchant on the map service.

In response to receipt of the landmark adding request, in step 508, the map-service device 3 adds a landmark on the map service based on the location of the merchant, and associate the access link with the landmark. As such, after a user using the map service clicks on the landmark, the access link may be provided to the user.

It is noted that in some embodiments, the landmark adding request of the merchant may further include information related to the merchant, such as a merchant name, an address, opening hours, a telephone number, etc. The information related to the merchant may then also be associated with the landmark, that is, after the user using the map service clicks on the landmark, the information related to the merchant may be provided to the user.

It is noted that in some embodiments, prior to step 505, the merchant-end device 2 may first output the service-related data for the merchant-end staff to review, and after reviewing the service-related data and finding it correct, the merchant-end staff may operate the merchant-end device 2 to input a confirmation signal. In response to receipt of the confirmation signal, the merchant-end device 2 proceeds to transmit the service-related data to the server 1 as an entry of to-be-searched service-related data.

As such, the process for generating and uploading the service-related data is completed. In some embodiments, the merchant-end device 2 may further upload the service-related data to an online storage (e.g., a cloud storage).

Afterward, in the case where a user operating the client-end device 4 intends to search for a desired service (e.g., ordering a merchandise), he/she may operate the client-end device 4 to interact with the server 1 and/or the map-service device 3 to obtain the service-related data.

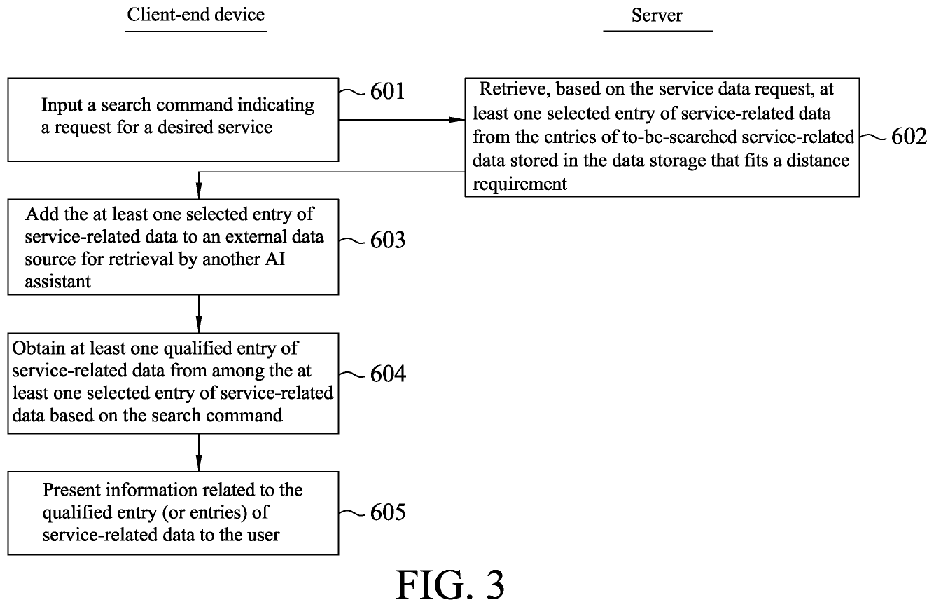

FIG. 3 is a flow chart illustrating steps of an exemplary process for obtaining the service-related data included in the method for providing service-related data via the AI assistant software program, according to one embodiment of the disclosure. In the embodiment of FIG. 3, the process is implemented by the user operating the client-end device 4, which is an AI assistant device that interacts with the server 1. In some embodiments, the client-end device 4 may be an electronic device that executes an AI assistant software program and that is connected to the map-service device 3. It is noted that at the time the process for obtaining the service-related data is being implemented, a plurality of entries of to-be-searched service-related data are already stored in the data storage 14 of the server 1.

In step 601, the user operating the client-end device 4 inputs a search command indicating a request for a desired service (e.g., “find a nearby place for lunch”). In response to receipt of the search command, the client-end device 4 generates a service data request that includes the search command and a location of the client-end device 4 obtained from the positioning component 48, and transmits the service data request to the server 1. The search command may include one or more search criteria for the service requested by the user.

In some embodiments, the search command may be inputted by the user by typing or writing on a touch screen, using a spoken command, or in other manners. In some embodiments, when inputting the search command for a specific type of service, the user may add one or more search conditions. For example, when the user is searching for a hand-shaken drink, the user may add search conditions associated with the drink (e.g., customizable amount of sugar or ice). Alternatively, the user may add filtering conditions that exclude information the user does not wish to see. For example, when a user keeps a vegan diet, meals containing meat may be filtered out.

In response to receipt of the service data request, in step 602, the server 1 retrieves, based on the service data request, at least one selected entry of service-related data from the entries of to-be-searched service-related data stored in the data storage 14 that fits a distance requirement. In some embodiments, the category associated with the merchant that is indicated by the header information of the at least one selected entry of service-related data matches the search command inputted by the user and included in the service data request.

In some embodiments, the distance requirement may indicate that the location of the merchant included in the header information of the at least one selected entry of service-related data is within a predetermined distance from the location of the client-end device 4. The predetermined distance may be a default distance or a designated distance included in the service data request.

Then, the server 1 transmits the at least one selected entry of service-related data to the client-end device 4.

Then, in step 603, the client-end device 4 adds the at least one selected entry of service-related data to an external data source for retrieval by another AI assistant. For example, the AI assistant software program of the client-end device 4 transmits the at least one selected entry of service-related data to the online storage. Then, when another user operates another AI assistant device to implement the process of FIG. 3 to search for service-related data, the data stored in the online storage may then be retrieved by the AI assistant device.

Generally, in some embodiments, since the service-related data is encoded in the form of message posts, a large number of message posts may be first obtained, and can then be easily filtered based on preferences of the client which will be explained hereinafter.

Then, in step 604, the client-end device 4 executing the AI assistant software program obtains at least one qualified entry of service-related data from among the at least one selected entry of service-related data based on the search command. Specifically, the client-end device 4 determines whether any of the at least one selected entry of service-related data fits the search criteria included in the search command, and for each of the at least one selected entry of service-related data, the client-end device 4 designates the selected entry of service-related data as a qualified entry of service-related data in a case where the selected entry of service-related data fits the search criteria.

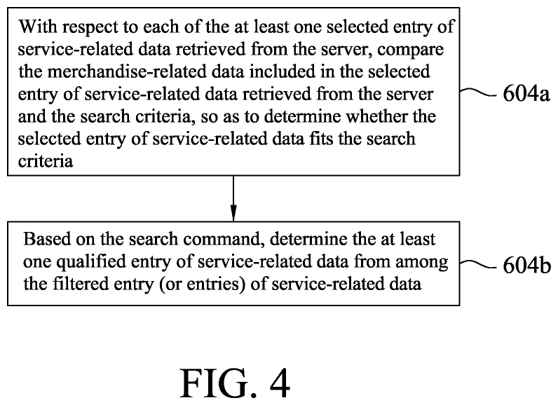

Specifically, FIG. 4 is a flow chart illustrating sub-steps of the operations of step 604 according to one embodiment of the disclosure.

In sub-step 604a, with respect to each of the at least one selected entry of service-related data retrieved from the server 1, the client-end device 4 compares the merchandise-related data included in the selected entry of service-related data retrieved from the server 1 and the search criteria, so as to determine whether the selected entry of service-related data fits the search criteria. For example, one service data request may indicate “find a beverage for a two-year old,” and one selected entry of service-related data may be associated with honey lemonade that includes a usage restriction of “not suitable for children under three.” As such, the merchandise associated with the selected entry of service-related data may be determined as not fitting the search criteria, and the selected entry of service-related data may be filtered out and discarded. On the other hand, when one selected entry of service-related data is associated with a beverage that is suitable for a two-year old, the selected entry of service-related data may be kept and may be designated as a filtered entry of service-related data. In another example, when a user who is glucose intolerant searches for a meal, selected entries of service-related data associated with food products that include too much sugar or alcohol may be discarded.

In sub-step 604b, based on the search command, the client-end device 4 determines the at least one qualified entry of service-related data from among the filtered entry (or entries) of service-related data.

Then, in step 605, the client-end device 4 presents information related to the qualified entry (or entries) of service-related data to the user. For example, the client-end device 4 may display the address and the telephone number of the merchant based on a qualified entry of service-related data. In the case where the merchant's merchandise is available for order using known ordering and delivery service platforms, the client-end device 4 may execute a third party application that is associated with the merchandise of the qualified entry of service-related data to suggest an order for the merchandise for the user, and the user may confirm whether to place the order. As such, the process is terminated.

It should be noted herein that the AI assistant software program executed by the merchant-end device 2 may be the same as or different from the AI assistant software program executed by the client-end device 4.

To sum up, embodiments of the disclosure provide a method for providing service-related data via an AI assistant software program. In the method, a merchant-end staff first operates a merchant-end device (which may be an AI assistant electronic device) to generate service-related data based on registration information that is associated with the merchant and product data that is associated with a merchandise the merchant offers and that is provided by the merchant. Then, the service-related data is uploaded to a server as an entry of to-be-searched service-related data, and the server 1 may be accessible to a user operating a client-end device that executes an AI assistant software program.

Additionally, in some embodiments, an entry of to-be-searched service-related data stored in the server may be first filtered out when a merchant associated with the entry of to-be-searched service-related data does not fit a distance requirement with respect to a current location of the client-end device when the client-end device is being operated by the user to send out a request (e.g., the user inputting a search command that indicates a request for a desired service and that includes one or more search criteria). Also, the client-end device may further filter out selected entry (or entries) of service-related data that do not fit the search criteria. In some cases, when the selected entry of service-related data includes a restrictive condition (e.g., a usage restriction or other conditions) that is not suitable based on the user's request, the client-end device may further filter out the selected entry of service-related data retrieved from the server based on the restrictive condition. In some embodiments, the user may add one or more search conditions and/or filtering conditions for filtering out any selected entry of service-related data that includes information not of interest to the user, and therefore the resulting qualified entry (or entries) of service-related data may be obtained and presented to the user with improved accuracy.

Moreover, by transmitting the at least one selected entry of service-related data to the online database, the resulting online database may include a large number of message posts that can be later used for other AI assistants.

It is noted that the message posts are encoded to be searchable by the AI assistant, and therefore may be easier for the client-end device to obtain. Since the client-end device may have already stored additional preferences associated with the user, the resulting qualified entry (or entries) of service-related data may be more suitable for the user than using the commercially available search engines.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for providing service-related data to be implemented using a service system that is connected to a server via a network, the server including a data storage, the service system including a merchant-end device that executes a first artificial intelligence (AI) assistant software program, the method comprising steps of:
a) obtaining, by the merchant-end device executing the first AI assistant software program, header information associated with a merchant based on registration information associated with the merchant, the registration information at least including a location of the merchant;
b) obtaining, by the merchant-end device executing the first AI assistant software program and based on product data that is associated with the merchandise and that is provided by the merchant, merchandise-related data associated with a merchandise provided by the merchant;
c) obtaining, by the merchant-end device executing the first AI assistant software program, content information based on the product data and the merchandise-related data;
d) generating, by the merchant-end device executing the first AI assistant software program, the service-related data using the header information and the content information; and
e) transmitting, by the merchant-end device executing the first AI assistant software program, the service-related data to the server as an entry of to-be-searched service-related data to enable the server to store the entry of to-be-searched service-related data in the data storage.

2. The method as claimed in claim 1, wherein step b) includes performing a search for domain knowledge associated with the merchandise based on the product data so as to obtain the merchandise-related data.

3. The method as claimed in claim 1, wherein:
step a) includes transforming the registration information into a serialization format using the first AI assistant software program so as to obtain the header information; and
step c) includes transforming the product data and the merchandise-related data into the serialization format using the first AI assistant software program so as to obtain the content information.

4. The method as claimed in claim 1, the service system further being connected via the network to a map-service device that provides a map service, the method further comprising, after step e):
in response to receipt of an access link to the entry of to-be-searched service-related data from the server, transmitting, by the merchant-end device executing the first AI assistant software program, a landmark adding request that includes the access link and the location of the merchant included in the registration information to the map-service device as a request for display of the merchant on the map service, so that the map-service device adds a landmark on the map service based on the location of the merchant, and associate the access link with the landmark.

5. The method as claimed in claim 1, the service system further including a client-end device that executes a second AI assistant software program, the method further comprising, after step e), steps of:
f) in response to receipt of a search command indicating a request for a desired service, by the client-end device executing the second AI assistant software program, generating a service data request that includes the search command and a location of the client-end device, and transmitting the service data request to the server, so that the server is enabled to, based on the service data request, retrieve at least one selected entry of service-related data from among entries of to-be-searched service-related data stored therein, and transmit the at least one selected entry of service-related data to the client-end device;
g) in response to receipt of the at least one selected entry of service-related data, adding, by the client-end device executing the second AI assistant software program, the at least one selected entry of service-related data to an external data source that is retrievable during retrieval-augmented generation (RAG); and
h) by the client-end device executing the second AI assistant software program, obtaining a qualified entry of service-related data from among the at least one selected entry of service-related data based on the search command.

6. The method as claimed in claim 5, further comprising executing, by the client-end device executing the second AI assistant software program, a third party application that is associated with a merchandise of the qualified entry of service-related data.

7. The method as claimed in claim 5, wherein:
in step a), the header information thus obtained includes the location of the merchant; and
in step f), the location of the merchant included in the header information of the at least one selected entry of service-related data is within a predetermined distance from the location of the client-end device.

8. The method as claimed in claim 5, wherein step h) includes, with respect to each of the at least one selected entry of service-related data retrieved from the server:
comparing the merchandise-related data included in the selected entry of service-related data and search criteria included in the search command, so as to determine whether the selected entry of service-related data fits the search criteria; and
filtering out the selected entry of service-related data in a case where the selected entry of service-related data does not fit the search criteria.

9. The method as claimed in claim 1, further comprising, between steps d) and e):
performing a signature operation by executing an asymmetric cryptography algorithm to generate a digital signature using a secret key, and attaching the digital signature to the service-related data.
